(19) United States
(12) Patent Application Publication
(10) Pub. No.: US 2008/0171623 A1
(43) Pub. Date: Jul. 17, 2008

(54) Structure of belt driven mechanism designed to ensure stability of operation of bearing

(75) Inventors: Tomoji Yamada, Kariya-shi (JP); Mitsuo Inagaki, Okazaki-shi (JP); Koji Kondo, Kiyosu-shi (JP)

Correspondence Address: OLIFF & BERRIDGE, PLC, P.O. BOX 320850, ALEXANDRIA, VA, 22320-4850, US

(73) Assignees: NIPPON SOKEN, INC., NISHIO-CITY (JP); DENSO CORPORATION, KARIYA-CITY (JP)

(21) Appl. No.: 12/007,237

(22) Filed: Jan. 8, 2008

(30) Foreign Application Priority Data
Jan. 11, 2007 (JP) 2007-003704

(51) Int. Cl. F16H 7/14

(52) U.S. Cl. 474/135

(57) ABSTRACT

A belt driven mechanism which may be employed to transmit engine torque to an automotive electric rotary accessory such as an alternator. The belt driven mechanism is equipped with bearings disposed between a pulley around which a belt is wound and a torque output rotor. The belt driven mechanism also includes a coil spring mechanism having a length with a first and a second end portion to establish transmission of torque between the pulley and the rotor. Each of the first and second end portion has a plurality of points of attachment to a corresponding one of the pulley and the rotor, thereby distributing a mechanical load acting on the pulley or the rotor into fractions. This avoids local exertion of the load on the bearings, thereby prolonging the service life and ensuring the reliability of operation of the bearings.

### CROSS REFERENCE TO RELATED DOCUMENT

The present application claims the benefit of Japanese Patent Application No. 2007-3704 filed on Jan. 11, 2007, the disclosure of which is incorporated herein by reference.

### BACKGROUND OF THE INVENTION

1. Technical Field of the Invention

The present invention relates generally to a belt driven mechanism which may be mounted passenger automobiles or autotrucks to transmit torque of a crankshaft of an engine to auxiliaries or accessories, and more particularly to such a belt driven mechanism designed to ensure the stability of operation of bearings and improve the service life thereof.

2. Background Art

Usually, a rotary electric accessory mounted in automobiles such as an alternator is driven by the engine power through a belt. A change in angular velocity of a crankshaft of the engine causes the rotary electric accessory to fail to follow rotation of the crankshaft, thus resulting in slippage of the belt which will lead to mechanical noises and reduction in service life of the belt. In order to avoid this problem, Japanese Patent First Publication No. 6-207525 teaches a serpentine belt driven mechanism which has a coil spring disposed between a pulley around which the belt is wound and an armature assembly of the alternator to permit the pulley and the armature assembly to rotate relative to each other elastically.

The serpentine belt driven mechanism, as taught in the above publication, encounters the problem in that torque acting on an end of the coil spring results in concentration of load on a single point on the pulley which is transmitted to two bearings disposed on both sides of the pulley. This will result in decreases in service life and reliability of operation of the bearings. Depending upon mechanical properties of the coil spring, an excessive load may be exerted by the end of the coil spring on the bearings through the pulley, so that the bearings produce reactive force and decreases in service life thereof. In order to alleviate this drawback, large-sized bearings may be used, but requiring the need for increasing the size of peripheral components, which results in an increase in entire manufacturing cost of the serpentine belt driven mechanism.

### SUMMARY OF THE INVENTION

It is therefore a principal object of the invention to avoid the disadvantages of the prior art.

It is another object of the invention to provide an improved structure of a belt driven mechanism equipped with bearings which is designed to decrease the degree of mechanical load locally exerted on the bearings to increase the service life and improve the reliability of operation thereof.

According to one aspect of the invention, there is provided a belt driven mechanism which may be employed to transmit engine torque to an automotive electric rotary accessory such as an alternator. The belt driven mechanism comprises: (a) a pulley to be rotated by a belt; (b) a rotary member; (c) bearings disposed between the pulley and the rotary member to permit the pulley and the rotary member to rotate relative to each other; and (d) a coil spring mechanism having a length with a first and a second end portion to establish transmission of torque between the pulley and the rotary member. The first end portion has a plurality of first points of attachment to the pulley. The second end portion has a plurality of second points of attachment to the rotary member. The first points are located away from each other in a circumferential direction of the coil spring mechanism. The second points are located away from each other.

Specifically, each of the coil spring mechanism is joined to one of the pulley and the rotary member at a plurality of points, thereby distributing a mechanical load acting on the pulley or the rotary member into fractions. This avoids local exertion of the load on the bearings, thus prolonging the service life and ensuring the reliability of operation of the bearings. This also permits peripheral components in the belt driven mechanism to be reduced in size and the entire manufacturing cost to be decreased.

In the preferred mode of the invention, the coil spring mechanism may be made up of a plurality of coil springs assembled to extend around an axis of rotation of the rotary member in a spiral fashion. Each of the coil springs is joined at one of opposed ends thereof to the pulley and at the other end thereof to the rotary member.

The coil springs may be laid to overlap each other in an axial direction thereof.

The coil springs may alternatively be laid to overlap each other in a radius direction thereof.

The coil spring mechanism may alternatively be made of a single coil spring with the first and second end portions. The first end portion has a plurality of ends which are located away from each other in a circumferential direction of the coil spring and attached at the first points to the pulley. Similarly, the second end portion has a plurality of ends which are located away from each other in the circumferential direction of the coil spring and attached at the second points to the rotary member.

The first points may be located at an equi-angular interval away from each other in the circumferential direction of the coil spring mechanism. Similarly, the second points may be located at an equi-angular interval away from each other in the circumferential direction of the coil spring mechanism.

The coil spring mechanism may be so designed that mechanical loads identical in degree with each other are exerted on the first points or the second points.

At least one of the pulley and the rotary member may have formed integrally therewith a support portion by which a corresponding one of the first and second portions of the coil spring mechanism is supported at one of groups of the first points and the second points are supported.

At least one of the pulley and the rotary member may alternatively have secured thereto a support portion by which a corresponding one of the first and second portions of the coil spring mechanism is supported at one of groups of the first points and the second points are supported.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a belt driven mechanism according to the first embodiment of the invention;

FIG. 2(a) is a top view which shows an assembly of coil springs installed in the belt driven mechanism of FIG. 1;

FIG. 2(b) is a side view which shows the assembly of coil springs, as illustrated in FIG. 2(a);

FIG. 2(c) is a bottom view of FIG. 2(b);

FIG. 3 is a side view which shows the first modification of an assembly of coil spring installed in the belt driven mechanism of FIG. 1;

FIG. 4(a) is a top view which shows the second modification of an assembly of coil springs installed in the belt driven mechanism of FIG. 1;

FIG. 4(b) is a side view of FIG. 4(a);

FIG. 5 is a side view which shows a coil spring to be installed in the belt driven mechanism of FIG. 1 according to the second embodiment of the invention;

FIG. 6 is a top view which shows a coil spring to be installed in the belt driven mechanism of FIG. 1 according to the third embodiment of the invention; and

FIG. 7 is a top view which shows a coil spring to be installed in the belt driven mechanism of FIG. 1 according to the fourth embodiment of the invention.

### DESCRIPTION OF THE PREFERRED EMBODIMENTS

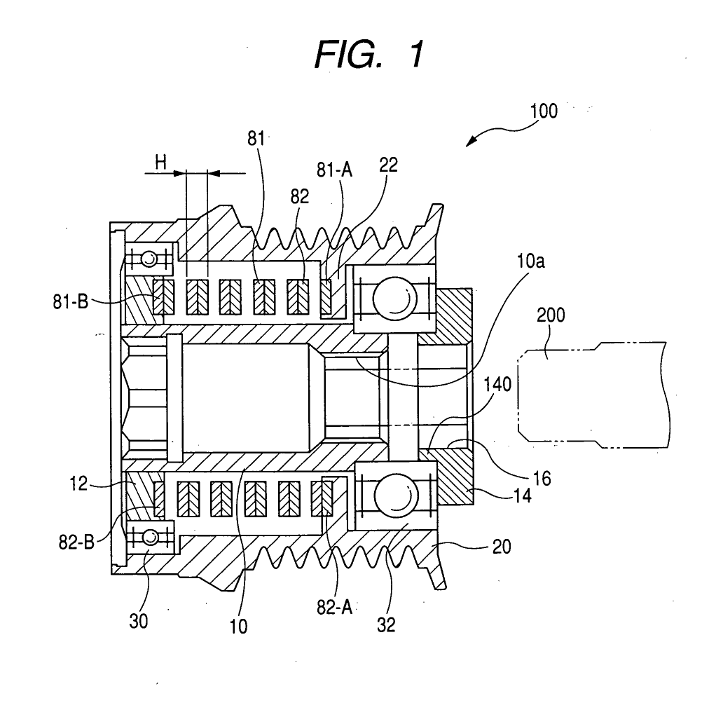

Referring to the drawings, wherein like reference numbers refer to like parts in several views, particularly to FIG. 1, there is shown a belt driven mechanism 100 according to the first embodiment of the invention which is designed to transmit torque of a crankshaft of an internal combustion engine (not shown) to a shaft 200 connected to an electric rotary accessory (not shown) such as an alternator mounted in the automotive vehicle. The belt driven mechanism 100 includes generally a rotor 10, an inner 12, a pulley 20, bearings 30 and 32, and an assembly of coil springs 81 and 82.

The rotor 10 is to be joined to the shaft 200 so that it rotates together with the shaft 200. The rotor 10 has formed in an inner periphery thereof an internal thread 10a which makes a joint with the shaft 200 firmly.

The pulley 20 has formed in an outer periphery thereof a plurality of V-grooves around which a belt (not shown) is wound which extends from the crankshaft of the engine. The pulley 20 also has formed on an inner periphery thereof an annular flange 22 which protrudes inwardly. The flange 22, as can be seen in FIG. 1, has formed on one of opposed surfaces a pair of recesses in which ends 81-A and 82-A of the coil springs 81 and 82 are fitted, respectively, to retain the coil springs 81 and 82. The two recesses are located at an angular interval of 180° away from each other in the surface of the flange 22. The belt driven mechanism 100 works to transmit torque of the crankshaft of the engine from the pulley 20 to the rotor 10 through the coil springs 81 and 82.

The bearings 30 and 32 are located away from each other in alignment with an axis of rotation of the belt driven mechanism 100 between the pulley 20 and the rotor 10. The bearing 30 is fit at an outer periphery of an outer ring thereof on an inner periphery of a portion of the pulley 20 which is located farther away from an opening of the belt driven mechanism 100 into which the shaft 200 is to be inserted and at an entire inner periphery of an inner ring thereof on an outer periphery of the inner 12. The inner 12 is made of an annular member separate from the rotor 10 and fit on a portion of the outer periphery of the rotor 10 which is located farther away from the opening of the belt driven mechanism 100 into which the shaft 200 is to be inserted. The inner 12 has a pair of recesses in which the other ends 81-B and 82B of the coil springs 81 and 82 are fitted and which are located at an angular interval of 180° away from each other.

The bearing 32 is located closer than the bearing 30 to the opening the opening of the belt driven mechanism 100 into which the shaft 200 is to be inserted. The bearing 32 is fit at an outer periphery of an outer ring thereof on the inner periphery of the pulley 20 and at an inner periphery of an inner ring thereof on the outer periphery of the rotor 10. A cover 14 is secured to an open end of the belt driven mechanism 100. The cover 14 is made of a hollow cylindrical member having formed therein a hole 16 through which the shaft 200 is to be inserted. The cover 14, as can be seen from the drawing, has an annular extension 140 which is fit in the inner periphery of the bearing 32 to cover the outer end of the bearing 32.

The coil springs 81 and 82 are disposed to make a mechanical connection between the pulley 20 and the inner 12. Each of the coil springs 81 and 82 is, as described above, retained at one of the ends thereof by the flange 22 formed integrally with the pulley 20 and at the other end thereof by the inner 12 secured to the rotor 10.

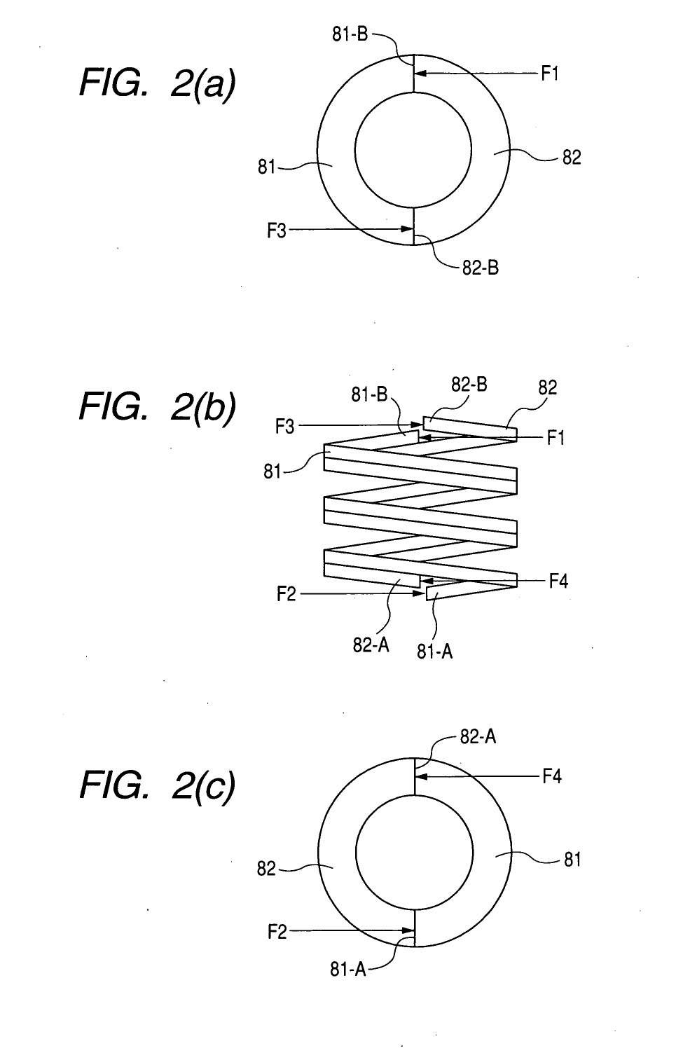

FIGS. 2(a), 2(b), and 2(c) illustrate an assembly of the coil springs 81 and 82. One of the ends of the coil spring 81 and one of the ends of the coil spring 82 are, as clearly illustrated in FIG. 2(a), diametrically opposed to each other, that is, located at an angular interval of 180° away from each other around a longitudinal center line of the assembly of the coil springs 81 and 82 (i.e., an axis of rotation of the belt driven mechanism 100). Similarly, the other end of the coil spring 81 and the other end of the coil spring 82 are, as clearly illustrated in FIG. 2(c), diametrically opposed to each other, that is, located at an angular interval of 180° away from each other around the longitudinal center line of the assembly of the coil springs 81 and 82. The coil springs 81 and 82 are identical in configuration, spring constant, and thickness with each other. If the thickness of each turn of the spiral assembly of the coil springs 81 and 82 is defined as H, the thickness of each turn of the coil springs 81 and 82 is H/2. The coil springs 81 and 82 are shifted by 180° to each other in the spiral direction.

As described above, the joint of the pulley 20 and the rotor 10 is achieved by attaching the ends of the coil springs 81 and 82 to the flange 22 of the pulley 20 and the inner 12 fitted on the rotor 10, thereby causing loads F1, F3, F2, and F4 exerted by either of the pulley 20 or the rotor 10 on the ends 81-B, 82-B, 81-A, and 82-A of the coil springs 81 and 82 be distributed to two places of each of the bearings 30 and 32 located 180° away from each other. Therefore, when the pulley 20 has undergone a change in angular velocity arising from a change in rotation of the crankshaft of the engine, and a rotary body such as a rotor of an automotive alternator which has a greater inertia and is connected to the shaft 200 continues to rotate, an excessive load is not exerted locally on the bearings 30 and 32 in the circumferential direction thereof which are disposed between the pulley 20 and the rotor 10. This results in an increase in service life of the bearings 30 and 32 and ensures the stability of operation thereof, which eliminates the need for increasing the size of the bearings 30 and 32 in order to avoid the deterioration thereof and permits peripheral components to be reduced in size or manufacturing cost.

The coil springs 81 and 82 are, as described above, assembled together around the axis of rotation of the rotor 10 and joined at the ends 81-A and 82-A to the pulley 20 and at the other ends 81-B and 82-B to the rotor 10. Specifically, the coil springs 81 and 82 are identical in shape and laid to overlap each other in the form of a spiral. Such assembling is usually easily, thereby improving the service life of the bearings 30 and 32 and ensuring the reliability of operation thereof.

The ends 81-A and 82-A or 81-B and 82-B of the coil springs 81 and 82 are affixed to each of the pulley 20 and the rotor 10 at an interval of 180° away from each other in the circumferential direction of the coil springs 81 and 82. In other words, the ends 81-A and 82-A or 81-B and 82-B of the coil springs 81 and 82 secured to each of the pulley 20 and the rotor 10 are symmetrical about the longitudinal center line of the assembly of the coil springs 81 and 82, thereby distributing the load acting on either of the pulley 20 or the rotor 10 into fractions to be exerted on the bearings 30 and 32 in the circumferential direction thereof, which also results in an increase in service life, ensures the stability of operation thereof, and permits peripheral components to be reduced in size or manufacturing cost. Use of the same size of the coil springs 81 and 82 causes the physical load acting between the ends 81-A and 82-A or 81-B and 82-B of the coil springs 81 and 82 and either of the pulley 20 or the rotor 10 at two points located 180° away from each other to be oriented in opposite directions as a couple of forces exerted on the bearings 30 and 32 evenly, thus further increasing the service life, ensuring the stability in operation thereof, and permitting the peripheral components to be reduced in size or manufacturing cost.

The joints of the ends 81-A and 82-A of the coil springs 81 and 82 to the pulley 20 are made at the flange 22 formed integrally with the pulley 20, thereby resulting in a decrease in discrete component parts of the belt driven mechanism 100. Additionally, the inner 12 to which the other ends 81-B and 82-B of the coil springs 81 and 82 to the inner 12 are joined is made as a part separate from the rotor 10 and mechanically attached to the rotor 10, thus permitting the rotor 10 to be machined to have a simple structure.

The flange 22 may alternatively be formed as a part separate from the pulley 20 and fit on the inner periphery of the pulley 20. The rotor 10 may alternatively be machined to have an annular protrusion formed integrally on the outer periphery thereof as the inner 12.

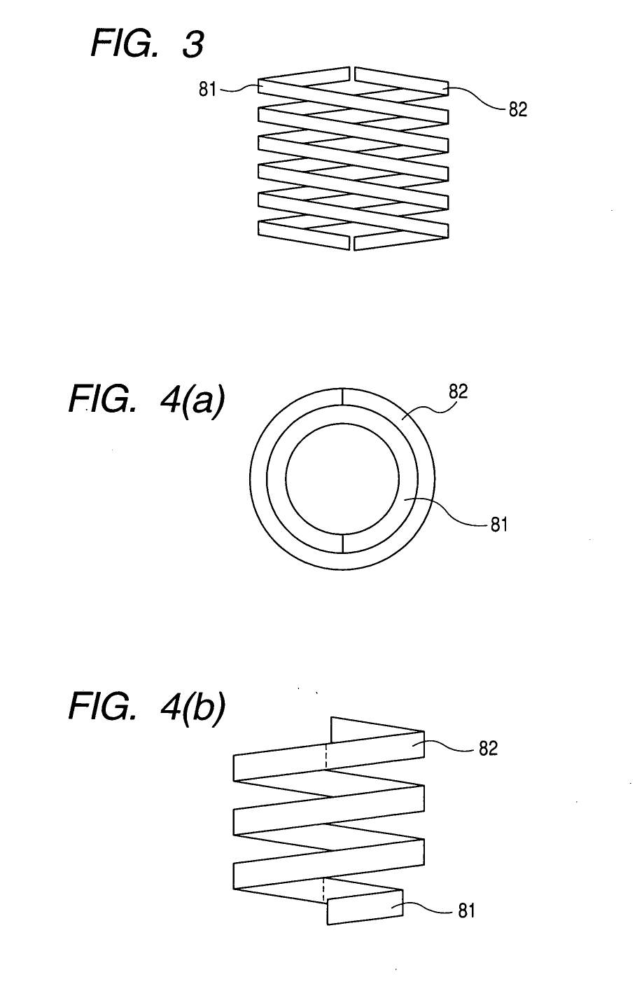

FIG. 3 illustrates the first modification of the assembly of the coil springs 81 and 82.

The coil springs 81 and 82 are, unlike the ones of FIGS. 2(a) to 2(c), assembled at intervals away from each other. The coil springs 81 and 82 are extend coaxially with the axis of rotation of the rotor 10 (i.e., the pulley 20) and have ends opposed diametrically to each other in the same manner as described above.

FIGS. 4(a) and 4(b) illustrate the second modification of the assembly of the coil springs 81 and 82.

The coil springs 81 and 82 are laid not to overlap each other in the axial direction of the assembly and wound coaxially with each other. In other words, the coil spring 81 is, as can be seen from FIG. 4(a), extends inside the coil spring 82 and laid to overlap the coil spring 82 in the radius direction of the assembly. It is advisable that the width and/or the thickness of either or both of the coil springs 81 and 82 be regulated to bring load (i.e., torque) acting on the ends of the coil spring 81 into agreement with that acting on the ends of the coil spring 82.

While the coil springs 81 and 82, as illustrated in FIGS. 2(a) to 2(c), are identical in size or type with each other, but they may alternatively be designed to have diameters different from each other and assembled so that they partially overlap in the axial direction of the assembly.

The coil springs 81 and 82, as illustrated in FIGS. 4(a) and 4(b), are laid in direct contact with each other. Specifically, the coil spring 81 has an outer periphery abutting on an inner periphery of the coil spring 82, but however, either or both of them may be altered in inner or outer diameter to have an air gap therebetween. Alternatively, the coil springs 81 and 82 of FIGS. 4(a) and 4(b) may be shifted vertically (i.e., the axial direction of the assembly) to have the ends thereof, like in FIG. 3, aligned with each other in the radius direction of the assembly.

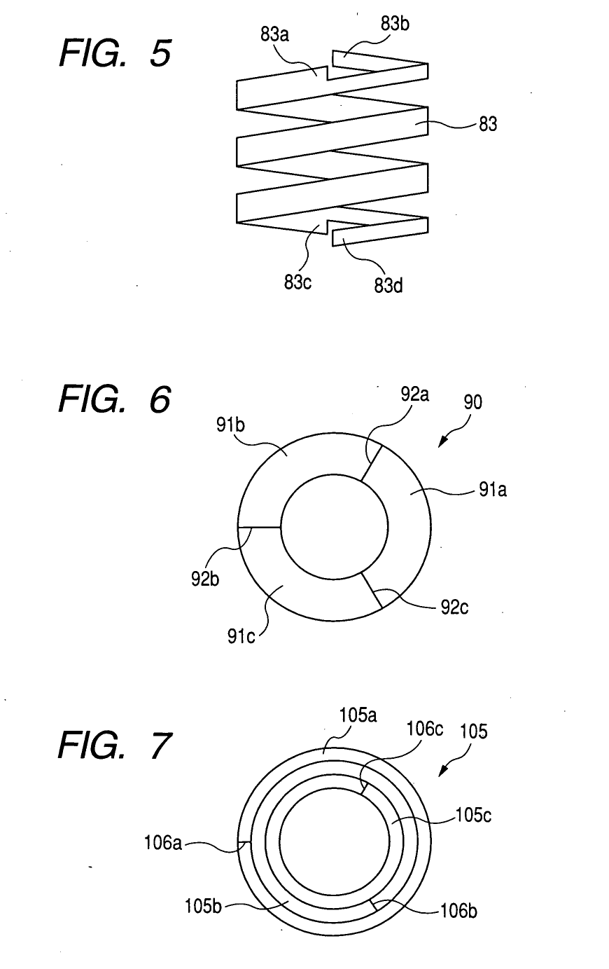

FIG. 5 illustrates the second embodiment of the invention.

Instead of the coil springs 81 and 82, a coil spring 83 is used in the belt driven mechanism 100, as illustrated in FIG. 1. The coil spring 83 is designed to have a pair of ends 83a and 83b formed at one end side thereof and a pair of ends 83c and 83d formed at the other end side thereof. The ends 83a and 83b are diametrically opposed to each other. Specifically, the end 83a is formed on a portion of the coil spring 83 which is located 180° away from the end 82a. Similarly, the ends 83c and 83d are diametrically opposed to each other. Specifically, the end 83c is formed on a portion of the coil spring 83 which is located 180° away from the end 82d. The end 83a is aligned with the end 83d in an axial direction of the coil spring 83. Similarly, the end 83b is aligned with the end 83c in the axial direction of the coil spring 83.

FIG. 6 illustrates the third embodiment of the invention.

Instead of the coil springs 81 and 82, a spring assembly 90 is used in the belt driven mechanism 100 of FIG. 1. The spring assembly 90 is made up of three coil springs 91a, 91b, and 91c which are assembled in a manner similar to that in FIGS. 2(a) to 2(c). Specifically, the coil springs 91a to 91c are laid to overlap each other in the axial direction of the spring assembly 90 to have three ends 92a, 92b, and 92c located 120° away from each other at each end side in a circumferential direction of the spring assembly 90 so that loads acting on the ends 92a to 92c may be identical with each other. The spring assembly 90 may alternatively be made up of four or more coil springs.

FIG. 7 illustrates the fourth embodiment of the invention.

Instead of the coil springs 81 and 82, a spring assembly 105 is used in the belt driven mechanism 100 of FIG. 1. The spring assembly 105 is made up of three coil springs 105a, 105b, and 105c which are assembled in a manner similar to that in FIGS. 4(a) and 4(b). Specifically, the coil springs 105a to 105c has diameters different from each other and are laid in contacting abutment in the radius direction of the spring assembly 105 to have three ends 106a, 106b, and 106c located 120° away from each other at each end side in a circumferential direction of the spring assembly 105 so that loads acting on the ends 106a to 106c may be identical with each other. The spring assembly 105 may alternatively be made up of four or more coil springs.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A belt driven mechanism comprising:
a pulley to be rotated by a belt;
a rotary member;
bearings disposed between said pulley and said rotary member to permit said pulley and said rotary member to rotate relative to each other; and
a coil spring mechanism having a length with a first and a second end portion to establish transmission of torque between said pulley and said rotary member, the first end portion having a plurality of first points of attachment to said pulley, the second end portion having a plurality of second points of attachment to said rotary member, the first points being located away from each other in a circumferential direction of said coil spring mechanism, the second points being located away from each other.

2. A belt driven mechanism as set forth in claim 1, wherein said coil spring mechanism includes a plurality of coil springs assembled to extend around an axis of rotation of said rotary member in a spiral fashion, each of the coil springs being joined at one of opposed ends thereof to said pulley and at the other end thereof to said rotary member.

3. A belt driven mechanism as set forth in claim 2, wherein the coil springs are laid to overlap each other in an axial direction thereof.

4. A belt driven mechanism as set forth in claim 2, wherein the coil springs are laid to overlap each other in a radius direction thereof.

5. A belt driven mechanism as set forth in claim 1, wherein said coil spring mechanism includes a coil spring with the first and second end portions, the first end portion having a plurality of ends which are located away from each other in a circumferential direction of the coil spring and attached at the first points to said pulley, the second end portion having a plurality of ends which are located away from each other in the circumferential direction of the coil spring and attached at the second points to said rotary member.

6. A belt driven mechanism as set forth in claim 1, wherein the first points are located at an equi-angular interval away from each other in the circumferential direction of said coil spring mechanism, and wherein the second points are located at an equi-angular interval away from each other in the circumferential direction of said coil spring mechanism.

7. A belt driven mechanism as set forth in claim 6, wherein said coil spring mechanism is so designed that mechanical loads identical in degree with each other are exerted on the first points or the second points.

8. A belt driven mechanism as set forth in claim 1, wherein at least one of said pulley and said rotary member has formed integrally therewith a support portion by which a corresponding one of the first and second portions of said coil spring mechanism is supported at one of groups of the first points and the second points are supported.

9. A belt driven mechanism as set forth in claim 1, wherein at least one of said pulley and said rotary member has secured thereto a support portion by which a corresponding one of the first and second portions of said coil spring mechanism is supported at one of groups of the first points and the second points are supported.
